(19) United States
(12) Patent Application Publication
(10) Pub. No.: US 2025/0034341 A1
(43) Pub. Date: Jan. 30, 2025

(54) METHODS FOR INCORPORATING DYNAMIC BONDS INTO EXISTING POLYMERS

(71) Applicant: Northwestern University, Evanston, IL (US)

(72) Inventors: Daniel Ryan Hart, Chicago, IL (US); Julia A. Kalow, Evanston, IL (US); Joseph V. Accardo, Ft. Myers, FL (US)

(21) Appl. No.: 18/775,233

(22) Filed: Jul. 17, 2024

Related U.S. Application Data
(60) Provisional application No. 63/529,193, filed on Jul. 27, 2023.

(51) Int. Cl. C08J 3/24; C08F 136/08; C08G 61/08; C08K 5/37

(52) U.S. Cl. CPC C08J 3/24; C08F 136/08; C08G 61/08; C08K 5/37; C08G 2261/132; C08G 2261/135; C08G 2261/145; C08G 2261/18; C08G 2261/3324; C08G 2261/3342; C08G 2261/418; C08G 2261/73; C08G 2261/76; C08J 2309/00; C08J 2365/00

(57) ABSTRACT

Synthetic methods for forming a crosslinked polymer network with dynamic bonds within its crosslinks from a pre-existing unsaturated organic polymer are provided. The dynamic bonds enable the resulting crosslinked polymer network to be chemically or mechanically recycled or otherwise reprocessed. Also provided are crosslinked polymer networks made using the synthetic methods and methods for reprocessing the crosslinked polymer networks using thiol exchange reactions.

### CROSS-REFERENCE TO RELATED APPLICATIONS

The present application claims priority to U.S. provisional patent application No. 63/529,193 that was filed Jul. 27, 2023, the entire contents of which are incorporated herein by reference.

### REFERENCE TO GOVERNMENT RIGHTS

This invention was made with government support under grant number CHE1901635 awarded by the National Science Foundation. The government has certain rights in the invention.

### BACKGROUND

Plastic materials can be broadly broken down into two categories: thermoplastics and thermosets. While thermoplastics are recyclable in principle, closed-loop recycling of materials that maintain their properties and value is impeded by degradation. Thermosets are functionally unrecyclable due to their cross-linked structure. These challenges have led to a large buildup of plastic waste in landfills and in the environment.

Between 1950 and 2015, approximately 6,300 megatons of plastic were produced and thrown away, with 12% of that waste getting incinerated, 9% recycled, and the rest disposed in landfills or leaked into the environment. (Geyer, R. et al., Sci. Adv. 2017, 3, e1700782.) Thermoplastics are generally considered recyclable because they are non-cross-linked polymers that can flow and be remolded. Unfortunately, thermoplastics can only be recycled 2-3 times in practice because thermal and mechanical chain scission during reprocessing erode their mechanical properties. Thermosets are more durable than thermoplastics because they are composed of cross-linked polymer strands, resulting in covalent polymer networks. These materials are used in many applications that require robust mechanical properties such as automobiles and windmills. Due to their enhanced mechanical properties and cross-linked structures, thermoset materials will decompose before flowing, hindering their recycling. These barriers to recyclability demonstrate a need for a more sustainable material design.

Existing methods for disposing of thermoset waste include incineration, pyrolysis, or solvolysis. Unfortunately, these methods have primarily focused on degrading polymers or producing secondary polymeric products, not reusing the polymers in an equivalent manner. In recent decades, research shifted towards more circular polymer recycling using a new class of materials known as covalent adaptable networks (CANs). CANs are cross-linked with dynamic bonds that rearrange in response to specific stimuli, usually heat. The first CANs were cross-linked using dissociative chemical reactions, such as furan-maleimide Diels-Alder or reversible radicals. (Chen, X. et al., Science 2002, 295, 1698-1702; Zhang, Y. et al., Macromolecules 2009, 42, 1906-1912; Higaki, Y. et al., Macromolecules 2006, 39, 2121-2125; Nicolaÿ, R. et al., Macromolecules 2010, 43, 4355-4361.) Unfortunately, radical chemistries can produce undesired cross-linking through termination reactions, while dissociative chemistries like the Diels-Alder cycloaddition favor an unbonded state at elevated temperature or high dilution. These drawbacks led the Leibler group to create networks with ester cross-links that exchange via an associative transesterification mechanism. (Montarnal, D. et al., Science 2011, 334, 965-968.) Leibler coined this class of associative CANs vitrimers due to their silica-like change in viscosity as a function of temperature.

Since 2011, many different types of associative dynamic bonds have been investigated, with common examples being transesterification and vinylogous urethanes. (Montarnal, D. et al., 2011; Denissen, W. et al., Adv. Funct. Mater. 2015, 25, 2451-2457.) A dithioalkylidene dynamic cross-linker based on Meldrum's acid (MA) that undergoes thiol exchange via conjugate addition-elimination has also been developed. This exchange reaction does not require a catalyst. Cross-linking thiol-grafted polydimethylsiloxane (PDMS) with MA afforded an elastomer that could be reprocessed more than 10 times and maintain its original mechanical properties. (Ishibashi, J. S. A. et al., ACS Macro Lett. 2018, 7, 482-486.) Dithioalkylidenes can be synthesized from various acyclic and cyclic diones and the cross-linker structure can tune the timescales of stress relaxation in the bulk material. (El-Zaatari, B. M. et al., Polym. Chem. 2020, 11, 5339-5345.)

While virgin vitrimer networks could present a potential solution for future thermoset recyclability, this does not address current thermoplastic and thermoset waste. Chain scission and contamination that occur during recycling processes erode the mechanical properties of thermoplastics. This erosion can be overcome by converting waste thermoplastics into vitrimers using processes like reactive extrusion. (Qiu, J. et al., Macromolecules 2021, 54, 703-712; Röttger, M. et al., Science 2017, 356, 62-65; Kar, G. P. et al., J. Mater. Chem. A 2020, 8, 24137-24147; Fenimore, L. M. et al., J. Mater. Chem. A 2022, 10, 24726-24745.) Incorporating dynamic bonds into non-dynamic thermosets, or vitrimerization, has also been used to make thermoset waste recyclable while maintaining its desirable mechanical properties. (Bandegi, A. Global Challenges 2022, 6, 2200036; Yue, L. et al., ACS Sustainable Chem. Eng. 2020, 8, 12706-12712; Yue, L. et al., Global Challenges 2019, 3, 1800076; Yuc, L. et al., ACS Macro Lett. 2020, 9, 836-842.)

### BRIEF DESCRIPTION OF THE DRAWINGS

Illustrative embodiments of the invention will hereafter be described with reference to the accompanying drawings, wherein like numerals denote like elements.

FIG. 1 shows a generic reaction scheme for inserting norbornene dithioalkylidene monomers into the backbone of an unsaturated polymer.

FIG. 2 shows a more detailed reaction scheme for inserting norbornene dithioalkylidene monomers into the backbone of an unsaturated polymer using an olefin metathesis catalyst.

FIG. 3 shows a reaction scheme for inserting norbornene dithioalkylidene monomers into polyisoprene using cyclooctene comonomers to reduce steric hindrance.

FIG. 4 shows a generic reaction scheme for the vitrimerization of a polymer having norbornene dithioalkylidene monomers incorporated into its backbone chain.

FIG. 5 shows a reaction scheme for the vitrimerization of a polymer having norbornene dithioalkylidene monomers incorporated into its backbone chain and the subsequent cleavage of crosslinks in the vitrimer using dithiothreitol. R=R² in FIG. 2.

FIG. 6 shows nuclear magnetic resonance (NMR) spectra of pure polyoctene (top) and the copolymers resulting from ROMP (middle) and cross-metathesis (bottom).

FIG. 7 shows various unsaturated polymers that have norbornene dithioalkylidene monomers incorporated into their backbone.

FIG. 8 shows GPC traces of a polybutadiene polymer with the inserted ND crosslinkers made with different concentrations of a Hoveyda-Grubbs II catalyst.

FIG. 9 shows results of storage modulus measurements on a crosslinked PB-based polymer.

FIG. 10 shows stress relaxation measurements of PB-based polymer network at different temperatures were obtained.

FIG. 11 shows stress relaxation measurements of PB-based polymer networks studied at temperatures of 130° C. and below

FIG. 12 shows the results of testing material creep for trans-majority PB-based polymer networks.

FIG. 13 shows a modified synthesis procedure for making a PB-based copolymer using a Umicore M3002 catalyst.

FIG. 14 is a graph of the final molecular weights of PB-based polymers made using different concentrations of a Umicore M3002 catalyst.

FIG. 15 shows the results of a dynamic mechanical thermal analysis of PB-based polymer networks made using the Umicore M3002 catalyst.

### DETAILED DESCRIPTION

Synthetic methods for forming a crosslinked polymer network with dynamic bonds within its crosslinks from a pre-existing unsaturated organic polymer are provided. The dynamic bonds enable the resulting crosslinked polymer network to be chemically or mechanically recycled, self-healed, or otherwise reprocessed. Also provided are crosslinked polymer networks made using the synthetic methods and methods for reprocessing the crosslinked polymer networks using thiol exchange reactions.

The synthetic methods are advantageous because they can be applied to existing commodity polymers rather than requiring the synthesis of new polymers, and they do not create ionic groups or require ions to function. Thus, the methods enable rubber and other polymers that are generally downcycled to lower-value products to be reprocessed into the original or new products via, for example, injection-molding.

The crosslinked polymer networks are made from organic polymers having unsaturated carbon-carbon bonds along their linear backbone chains. Such polymers include unsaturated polyalkenes. The polymers that are used as a starting material may be homopolymers or copolymers formed from two or more different monomers. Examples of polymers from which the crosslinked polymer networks can be formed include diene elastomers, such as polybutadiene, polyisoprene, and styrene butadiene copolymer, as well as unsaturated polyolefins, such as poly(cyclooctene). Depending on the starting polymer and the catalyst being used, the resulting crosslinkable copolymers may be trans-majority (i.e., having more trans alkene bonds and cis-alkene bonds) or may be cis-majority ((i.e., having more cis alkene bonds and cis-alkene bonds). By way of illustration, the trans:cis ratio for a trans-majority polymer may be at least 2:1, at least 3:1 or at least 4:1. Similarly, the cis:trans ratio for a cis-majority polymer may be at least 2:1, at least 3:1 or at least 4:1.

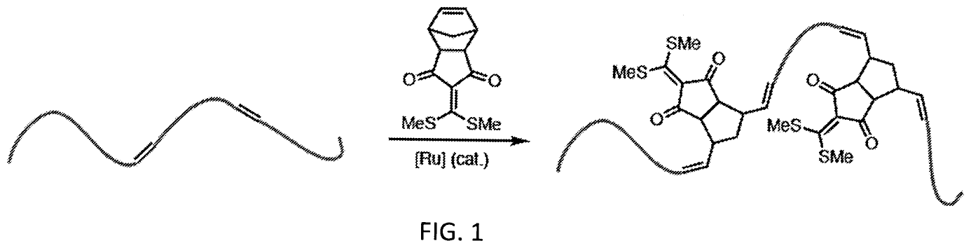

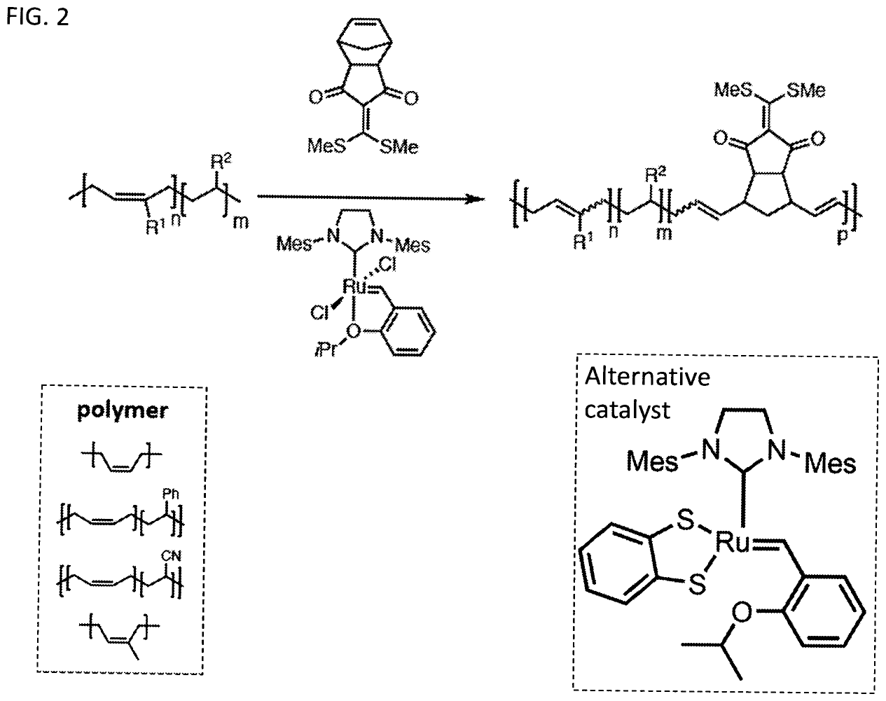

The synthesis of a crosslinkable polymer from a pre-existing polymer having unsaturation along its backbone is shown schematically in FIGS. 1 and 2. In the methods, norbornene dithioalkylidene (ND) monomers are incorporated into the unsaturated carbon backbone chain of a pre-existing polymer via a combination of ring-opening and cross-metathesis. As shown in FIG. 1, an ND monomer is a monomer having a norbornene group and a dithioalkylidene group. In FIG. 1, a generic polymer backbone chain is represented by a solid grey line with unsaturated carbon-carbon bonds within the chain represented as double solid lines. As a result of the reaction between the norbornene group of the monomer and the unsaturated polymer, the ND monomers are inserted into the polymer chain at the sites of unsaturation, producing a polymer having pendant dithioalkylidene groups. In the reaction shown in FIGS. 1 and 2, the alkyl groups of the dithioalkylidene are methyl groups. However, one or both of the methyl (“Me”) groups in the ND monomers could be independently replaced by other alkyl groups, including C₂-C₁₂ alkyl groups, or by aromatic groups, such as benzyl mercaptan groups.

The reaction may be carried out in solution or under solvent-free conditions. Solutions may be formed by adding the reactants to a solvent or solvent mixture in which the reactants are sufficiently soluble to allow for the reaction to proceed. The particular solvents used will depend upon the particular pre-existing polymer and ND monomer being used. One example of a solvent that can be used is dichloromethane (DCM). To facilitate the reaction, an olefin metathesis catalyst may be added to the reaction mixture. Examples of olefin metathesis catalysts include ruthenium olefin metathesis catalyst and molybdenum olefin metathesis catalysts. These catalysts are generally metal (e.g., Ru or Mo) organometallic compounds, including metal chelates, such as Grubbs catalysts and Hoveyda-Grubbs catalysts. The olefin metathesis catalysts may be trans-selective or cis-selective.

FIG. 2 shows the reactions between an ND monomer and various illustrative, but non-limiting, pre-existing homopolymers and copolymers. In FIG. 2, n, m, o, p, and q represent the number of each type of monomer or repeat unit in the polymer. For a homopolymer, m is zero. R¹ represents an H atom or an alkyl group, such as a C₁-C₆ alkyl group. R² represent an H atom, or a substituent, such as an alkyl group, such as a C₁-C₆ alkyl group, an ester group, a carboxylic acid group, an aromatic group, such as a phenyl group, or cyano group. Three examples of polymers that can be used as a starting material are shown in the lower left panel of FIG. 2, and an alternative olefin metathesis catalyst that is cis-selective in shown in the lower right panel of FIG. 2.

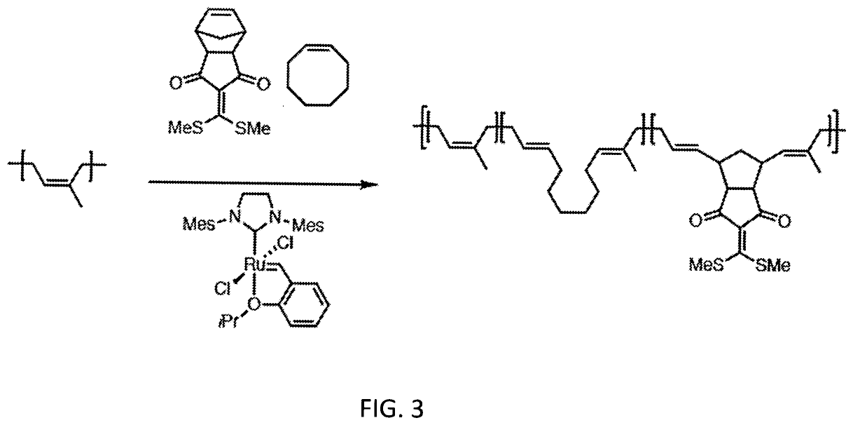

For starting polymers having side chains, steric hindrance may interfere with the reaction between the polymer and the ND monomers. If this is an issue, an additional monomer that creates less steric hindrance than the ND and that is also able to undergo ring-opening and cross-metathesis reactions can be included in the reaction mixture. Monomers having less steric hindrance than ND and that can undergo ring-opening and cross-metathesis reactions include unsaturated cycloalkenes, such as cyclooctene, cyclooctadiene, or large (>C₁₄) unsaturated macrocycles. By way of illustration, the steric hindrance between ND monomers and polyisoprene may inhibit incorporation of the ND monomers into the polyisoprene. By adding cycloalkenes having an unsaturated carbon-carbon bond, such as cyclooctene, into the reaction mixture, both the ND monomers and the unsaturated cycloalkene monomers can be added into the polyisoprene backbone chain, as shown in FIG. 3. In some embodiments of the molar ratio of the ND monomer to additional monomer is in the range from 1:1 to 1:50. This includes embodiments in which the molar ratio of the ND monomer to additional monomer in the range from 1:5 to 1:20. However, ratios outside of these ranges can be used.

The weight ratio of ND to pre-existing polymer will depend upon the degree of unsaturation in the backbone chain of the pre-existing polymer and the desired crosslinking density in the final crosslinked polymer network. By way of illustration, polymer:monomer weight ratios in the range from 45:1 to 5:1 can be used. This includes weight ratios in the range from 20:1 to 10:1, where the monomer is the ND monomer or the combination of ND monomers and additional monomers that are included in the reaction to reduce steric hindrance, if such monomers are being used. However, ratios outside of these ranges can be used.

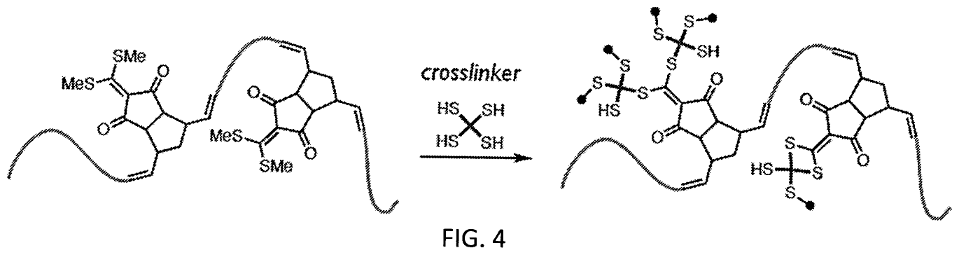

The polymer into which the ND monomers have been incorporated is then converted into a vitrimer by reacting the thioether groups (—SR, where R represents an alkyl group; e.g., —SMe) on the polymer with a crosslinker having at least two thiol (—SH) groups to form crosslinks with sulfide bonds between the polymer backbone chains (FIG. 4). (For simplicity, the other polymer backbone chains in the crosslinked polymer network in FIG. 4 are represented by solid black dots.) The crosslinker molecules may be branched molecules with the thiol groups on different branches or may be linear molecules with pendant thiol groups along a linear backbone chain. For illustrative purposes, the crosslinker molecule shown in FIG. 4 is a branched molecule having four thiol groups. However, the crosslinker may have only two thiol groups, may have three thiol groups, or may have more than four thiol groups. Mixtures of different crosslinkers may be used. Examples of crosslinkers having multiple thiol groups include pentaerythritol (3-mercaptopropionate) (PETMP), trimethylolpropane tris(3-mercaptopropionate), trimethylolpropane tris(thioglycolate), dipentaerythritol hexakis (3-mercaptpropionate), C₅-C₁₀ alkyl dithiols, and linear or branched polyethylene glycol thiols.

The atmosphere and temperature under which the crosslinking takes place may affect the nature of the final crosslinked polymer network. For this reason, it is desirable to conduct crosslinking under a non-oxidizing (e.g., O₂-free atmosphere), such as a nitrogen (N₂) atmosphere, to avoid oxidative crosslinking and promote the formation of a dynamically crosslinked polymer network. Additionally, the crosslinking should be conducted at a temperature at which oxidative crosslinking is avoided or minimized. For example, in some embodiments of the methods of crosslinking the polymers, the crosslinking is carried out at a temperature of no greater than 160° C., no greater than 150° C., or no greater than 130° C. By way of illustration only, crosslinking can be carried out at temperatures in the range from 50° C. to 130° C.

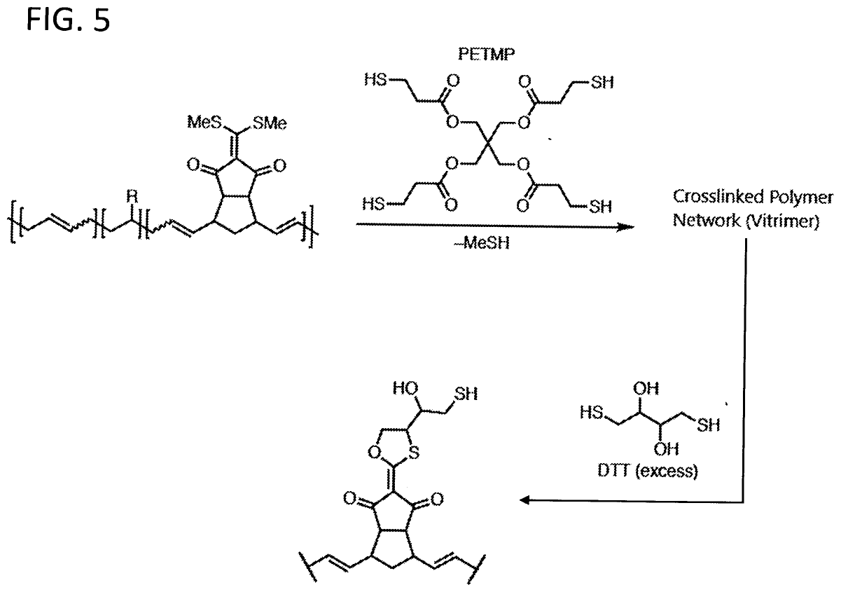

The crosslinks in the resulting crosslinked polymer network render the polymer network reprocessable because they can then be reversibly severed by heating the polymer networks and/or dissolving the crosslinked polymer network in a solvent comprising an excess of thiol small molecules that undergo thiol exchange with the crosslinks of the crosslinked polymer network. The small molecules may be, for example, dithiols or monothiols, in which one or more thiol groups may be attached to a short (e.g., C₂ to C₁₂, including C₄ to C₁₀) branched or linear carbon chain. Suitable thiol small molecules include dithiothreitol (DTT) or alkyl thiols, such as dodecanethiol. Aromatic thiols, such as benzyl mercaptan can also be used. FIG. 5 illustrates the steps in forming and reprocessing a crosslinked polymer network using PETMP as an illustrative crosslinker and DTT as an illustrative thiol molecule. This same process can be carried out with other crosslinked polymer networks and other thiol small molecules described herein. The solution may be heated above room temperature for a time sufficient to sever the crosslinks in the polymer network. For example, the solution may be heated to a temperatures of 80° C. or higher (e.g., 100° C. to 150° C.) for a time of one hour or longer (e.g., from 1 hour to 24 hours. However, temperatures and/or times outside of these ranges may be used.

The polymer networks can be mechanically reprocessed by heating (for example, hot-pressing) these polymer networks to temperatures of 100° C. or higher (e.g., 100° C. to 150° C.).

Generally, the crosslinking density in the vitrimers should be sufficient to provide the crosslinked polymer network with mechanical properties suitable for its intended purpose, while still allowing the crosslinked polymer network to be reprocessed. By way of illustration, the weight ratio of ND to pre-existing polymer may be selected to provide a crosslinking density in the range from 0.0001 mol/g to 0.0015 mol/g.

### Example

This example describes the design of dithioalkylidene cross-linkers for converting various unsaturated thermoplastics into vitrimers.

Monomer Synthesis: A norbornene dithioalkylidene (ND) monomer 2-(bis(methylthio)methylene)-3a,4,7,7a-tetrahydro-1H-4,7-methanoindene-1,3 (2H)-dione was synthesized according to Scheme 1.

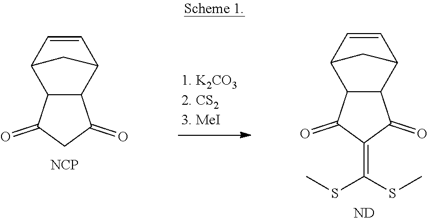

The synthesis was carried out as follows:

3a,4,7,7a-tetrahydro-1H-4,7-methanoindene-1,3 (2H)-dione. Dicyclopentadiene was cracked by heating to 170° C. and collecting the pure cyclopentadiene. The freshly cracked cyclopentadiene (2.99 mL, 36.4 mmol), cyclopent-4-ene-1,3-dione (1.00 g, 10.4 mmol) and toluene (25 mL) were added to a flask and stirred at room temperature overnight. White precipitate formed very quickly, starting to form within a few minutes. The mixture continued to get less and less yellow over the course of a few hours. By the next morning the solution was full of a powdery white precipitate that was extremely thick. The precipitate was collected by vacuum filtration and weighed. The product was collected as a white powder in 92% yield. (Reference: Angew. Chem. Int. Ed., 2012, 51, 8648.)

2-(bis(methylthio)methylene)-3a,4,7,7a-tetrahydro-1H-4,7-methanoindene-1,3 (2H)-dione. Potassium carbonate (1.541 g, 11.15 mmol) and 3a,4,7,7a-tetrahydro-1H-4,7-methanoindene-1,3 (2H)-dione (822 mg, 5.07 mmol) were added to a vial. Anhydrous dimethylformamide (DMF) (29 mL) was added, and the mixture was stirred for 30 min. Then CS₂ (0.674 mL, 11.15 mmol) was added and stirred for 3 hr at RT (room temperature, ˜23° C.); the solution turned cherry red. Methyl iodide (0.694 mL, 11.15 mmol) was then added slowly. The solution became yellow and clear. After stirring overnight, the reaction mixture was heated to 40° C. and placed under vacuum to remove the solvent. Dichloromethane (10-15 mL) was added to the residue, which was sonicated until no residue remained adhered to the walls of the flask. The resulting slurry was then filtered and concentrated to provide the crude product. The product was purified on a column (gradient from 12-100% ethyl acetate in hexanes) to purify. 1.157 g of the product was isolated, giving an 86% yield.

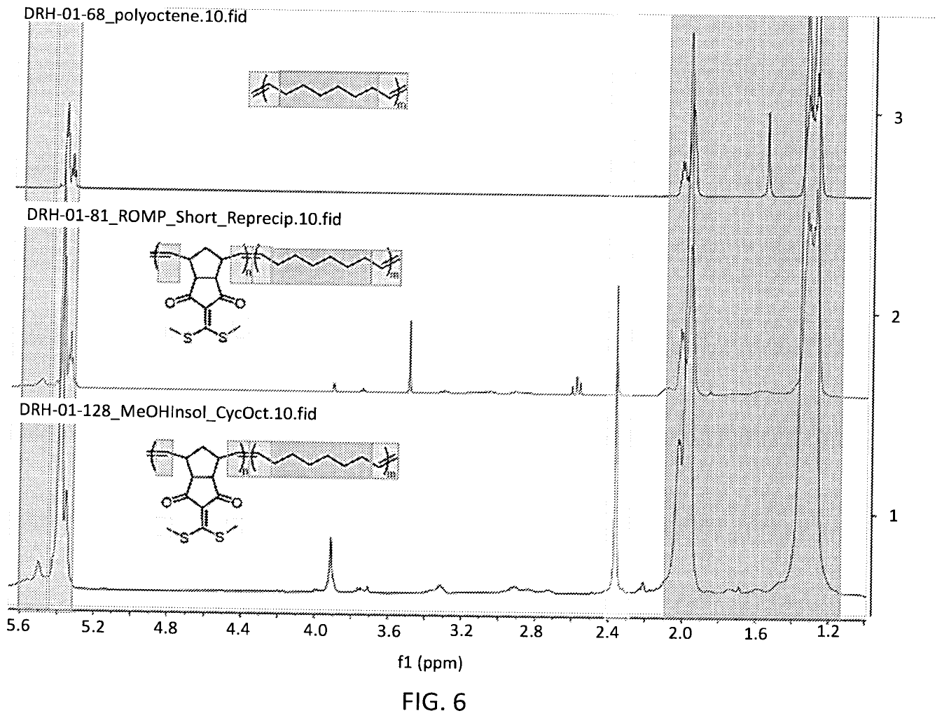

Polymer Synthesis using ND: First, the ROMP reactivity of the ND monomer used in this example was tested. The ND homopolymerized sluggishly, likely due to its hindered endo conformation. To address this, ND was copolymerized with cis-cyclooctene (pCOE) in a 1:10 molar feed ratio. The resulting polymer (pCOE-ND) was characterized by gel permeation chromatography (GPC) and nuclear magnetic resonance (NMR) (FIG. 6) and showed a cross-linker/octene ratio comparable to the monomer feed ratio. To confirm that the cross-linker was still intact and able to undergo dynamic exchange following polymerization, the resulting polymer was dissolved in xylenes, mixed with 0.6 equivalents of pentaerythritol tetrakis(3-mercaptopropionate) (PETMP) relative to ND, and heated to 120° C. to facilitate bond exchange. After heating for two hours and leaving under vacuum overnight, a solid film was obtained that was insoluble in common laboratory solvents that dissolved the prepolymer. When these copolymers were cross-linked under oxygen-free conditions, the resulting gels were dynamic and could be redissolved by heating in an excess of free thiol. Control experiments with polycyclooctene (pCOE) and the copolymers showed that when cross-linking was carried out in the presence of oxygen, irreversible thiol-ene cross-linking could be initiated, which resulted in the formation of insoluble, non-vitrimeric networks.

Vitrimerization of a Pre-existing Polymer using ND: Next, ND was used to convert common thermoplastics into vitrimers. A combination of ring-opening and cross-metathesis incorporates this cross-linker into unsaturated polymers, such as polyisoprene and polybutadiene, as an alternative to vulcanization to create recyclable rubbers. pCOE was allowed to react overnight with Hoveyda-Grubbs catalyst II in the presence of the ND. The resulting polymer was characterized by NMR (FIG. 6) and looked qualitatively similar to the copolymers previously synthesized by ROMP, displaying the same additional peaks compared to the pCOE copolymer.

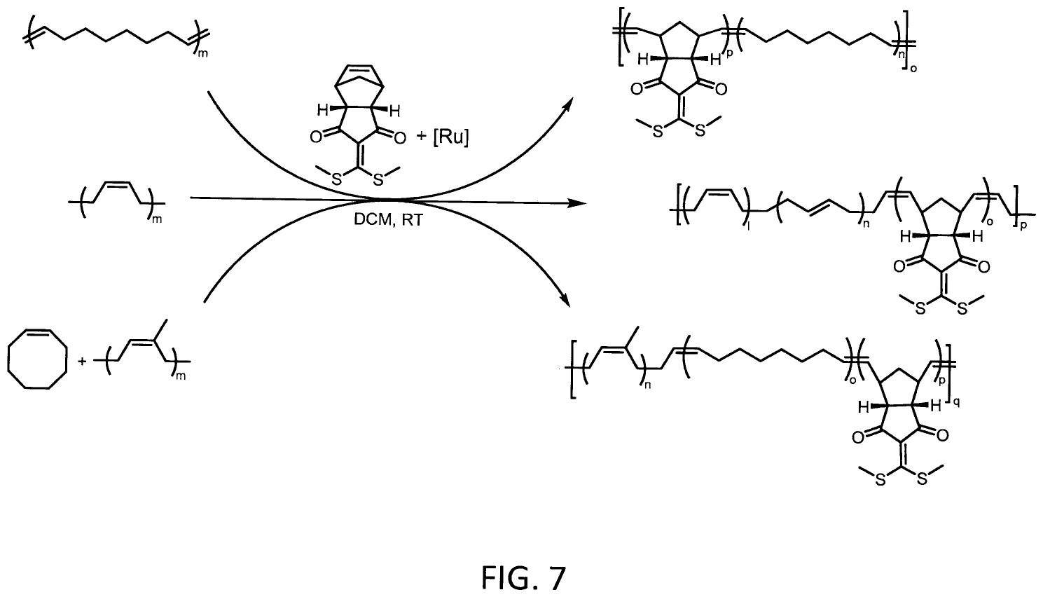

ND was also incorporated into other unsaturated polymers. After some optimization to minimize mass loss, ND was easily incorporated into polybutadiene (PB, FIG. 7). The vitrimerization of PB with ND was carried out using two procedures as follows:

Insertion of crosslinker into polybutadiene. Procedure 1:973 mg of polybutadiene (MW 200,000 to 300,000, primarily cis-1,4) was added to a 10 mL flask. 2-(bis(methylthio)methylene)-3a,4,7,7atetrahydro-1H-4,7-methanoindene-1,3 (2H)-dione (26 mg, 0.1 mmol) was added with ˜2 mL of DCM to the flask and the mixture was stirred until dissolved. Once dissolved, the solvent was removed in vacuo and then Hoveyda-Grubbs II catalyst (6.2 mg, 10 μmol) was added in 0.1 mL DCM. The mixture was stirred by hand with a spatula and began to form a gooey viscous liquid. A minimal amount of DCM (ca. 0.5 mL) was added until the mixture was dissolved and could be stirred well. The vial was capped with a septum and allowed to stir overnight. The following morning the flask was connected to a Schlenk line, and the solvent was allowed to evaporate slowly over 3 hours. The reaction was quenched with excess ethyl vinyl ether, dissolved in minimal DCM, and precipitated into methanol (˜ 40 mL). The precipitate was collected by centrifugation. Crosslinker incorporation was evaluated by 1H and DOSY NMR.

Insertion of crosslinker into polybutadiene. Procedure 2:10.045 g of polybutadiene (MW 200,000 to 300,000, primarily cis-1,4), 2-(bis(methylthio)methylene)-3a,4,7,7atetrahydro-1 H-4,7-methanoindene-1,3 (2H)-dione (1.9356 g, 7.27 mmol) and Hoveda-Grubbs II catalyst (90.92 mg, 145 μmol) were added to a 100 mL round bottom flask. The flask was evacuated under vacuum and refilled with nitrogen 3 times. Degassed DCM (33.3 mL) was then added, and the mixture was allowed to stir for 26 hours under nitrogen. At the end of 26 hours the reaction was quenched by adding an excess of ethyl vinyl ether and stirring for an additional 30 minutes. The polymer was collected by precipitation and centrifugation in acetone. Crosslinker incorporation was evaluated by 1H and DOSY NMR and Gel Permeation Chromatography.

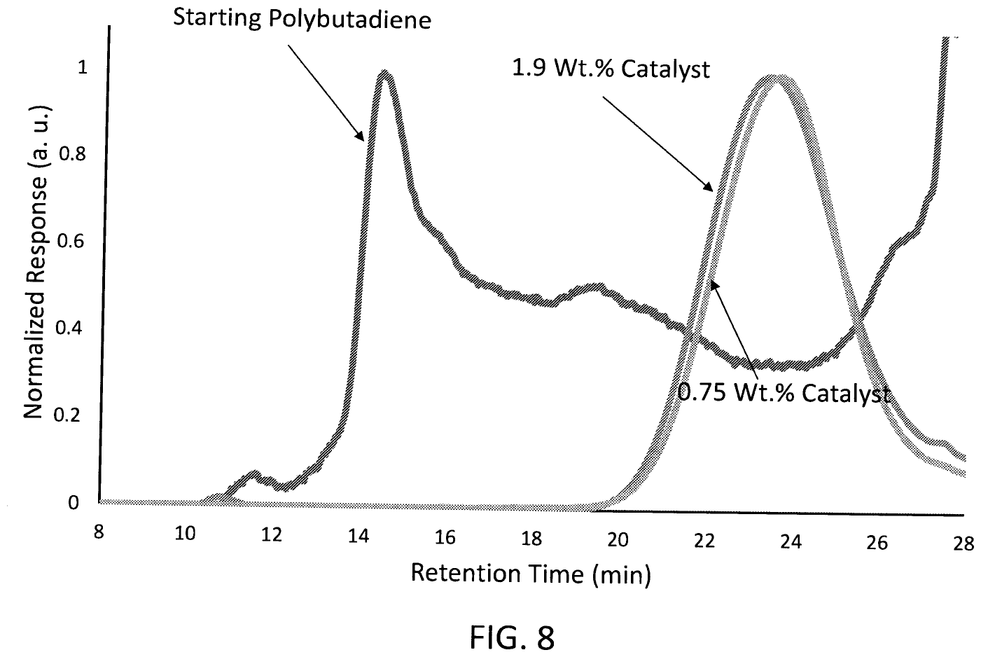

GPC traces of the PB with the inserted ND crosslinker made with Procedure 2 using different concentrations of the Hoveyda-Grubbs II catalyst are shown in FIG. 8. The resulting polymers were trans-majority (trans:cis alkenes ratio of 4:1) polymers and the molecular weight (MW) (˜14,000 g/mol) of the final modified polymers was independent of amount of catalyst added. The polymers having a majority of trans alkene bonds (i.e., trans:cis >1, ≥2, ≥3, ≥4) are referred to herein as “trans-majority” polymers.

It was more difficult to incorporate ND into polyisoprene (PI), presumably due to the steric hindrance of the tertiary olefin and endo ND. However, including the less-sterically hindered olefin cyclooctene in the reaction facilitated the incorporation of ND and created a cross-linkable terpolymer. Performing this reaction under these conditions resulted in a polymer mixture that was able to form a dynamically cross-linked solid. The vitrimerization of PI with ND was carried out as follows:

Insertion of crosslinker into polyisoprene. 200 mg of polyisoprene (MW ˜38,000 by GPC) was added to a 10 mL flask. 2-(bis(methylthio)methylene)-3a,4,7,7atetrahydro-1H-4,7-methanoindene-1,3 (2H)-dione (44.8 mg, 0.17 mmol) and cyclooctene (9.3 mg, 0.08 mmol) were added to the flask. The flask was evacuated and filled with N₂ three times before dissolving the mixture in minimal DCM (0.5-1 mL). Once dissolved, the Hoveyda-Grubbs II catalyst (10.5 mg, 16.8 μmol) was added in 0.1 mL DCM. The mixture was then subjected to 3 freeze-pump-thaw cycles. The reaction mixture was then allowed to stir for 72 hours. At the end of that time, the flask was connected to a Schlenk line, and the solvent was allowed to slowly evaporate over 3 hours. The reaction was quenched with excess ethyl vinyl ether, dissolved in minimal DCM, and precipitated into methanol (˜ 40 mL). The precipitate was collected by centrifugation. Crosslinker incorporation was evaluated by 1H and DOSY NMR.

Method of crosslinking modified polymers. Procedure 1:200 mg of modified polymer was added to a 4-mL vial and dissolved in a minimal volume of xylenes. Pentaerythritol (3-mercaptopropionate) (0.6 equivalents relative to ND incorporated into the polymer) was added to the mixture, which was mixed thoroughly. The vial was then placed in a small vacuum chamber and subjected to 5 cycles of evacuation and filling with N₂ (care must be taken to avoid excessive solvent boiling during this process). After filling for the final time with N₂, the entire chamber was submerged in an oil bath heated to 120° C. This was allowed to heat for between 2-12 hours before the chamber was removed from the oil bath and allowed to cool to room temperature. Once cool, the chamber was immediately placed under high vacuum to remove the remaining solvent. The polymer network was then obtained as a 1-2 mm thick film on the bottom of the vial.

Method of crosslinking modified polymers. Procedure 2:1.200 g of modified polymer and N-(1,3-Dimethylbutyl)-N′-phenyl-p-phenylenediamine (˜3 parts per hundred of polymer or 36 mg) were added to a 20-mL vial. 178.8 mg of pentacrythritol (3-mercaptopripionate) (0.6 equivalents relative to ND incorporated into the polymer) was dissolved in 1 mL of toluene and added to the mixture. The mixture was stirred by hand, adding in additional toluene as needed to achieve a pourable consistency. The mixture was then poured into a Teflon mold and placed in a nitrogen purged vacuum oven at 85° C. The mixture was allowed to heat for 1 hour under nitrogen and then placed under <1 torr vacuum and allowed to heat for an additional hour. The polymer network was then removed from the oven and can be de-molded.

Dynamic Mechanical Thermal Analysis of trans-majority PB-based polymer networks. Dynamic mechanical thermal analysis of the polymer networks (vitrimers) was performed on an ARES-G2 rheometer using the dynamic mechanical analysis tension attachment. Polymer network films were cut into a rectangle (approximately 8 mm by 30 mm) and mounted in the tensile attachment and set to oscillate 0.4 strain percent at 1 Hz while heating from −150° C. to 100° C. at 3° C./min.

It was observed that the atmosphere under which the crosslinking takes place and the processing temperature may affect the nature of the final crosslinked polymer network. When crosslinking was carried out under oxygen the resulting polymer network was permanently crosslinked. However, when crosslinking was carried out under nitrogen, the resulting polymer network was dynamically (reversibly) crosslinked and could be dissolved in a solution comprising DTT.

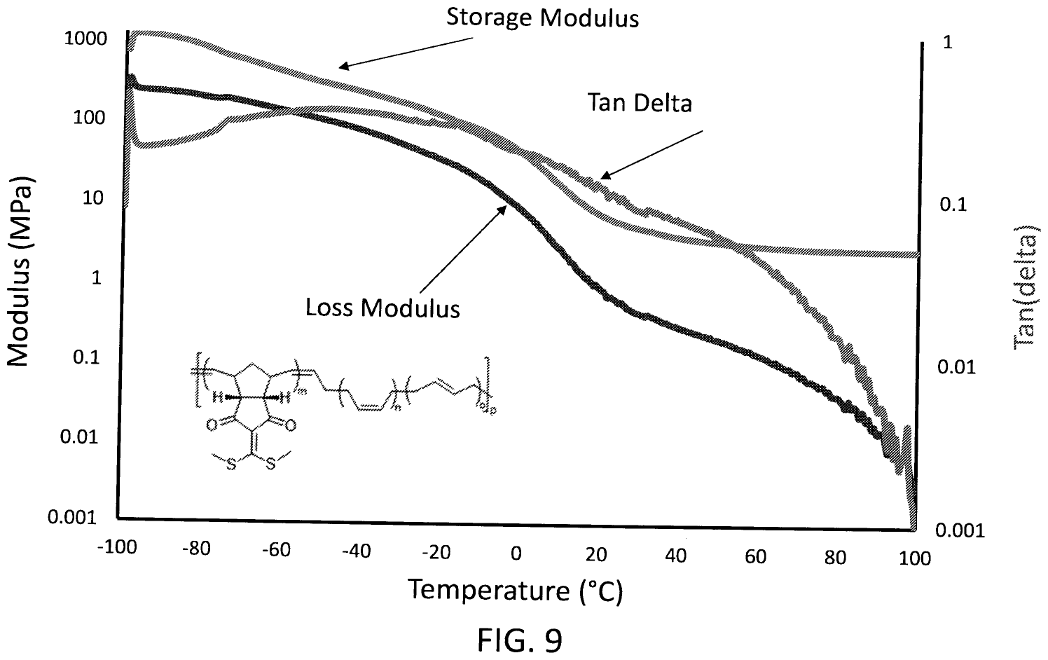

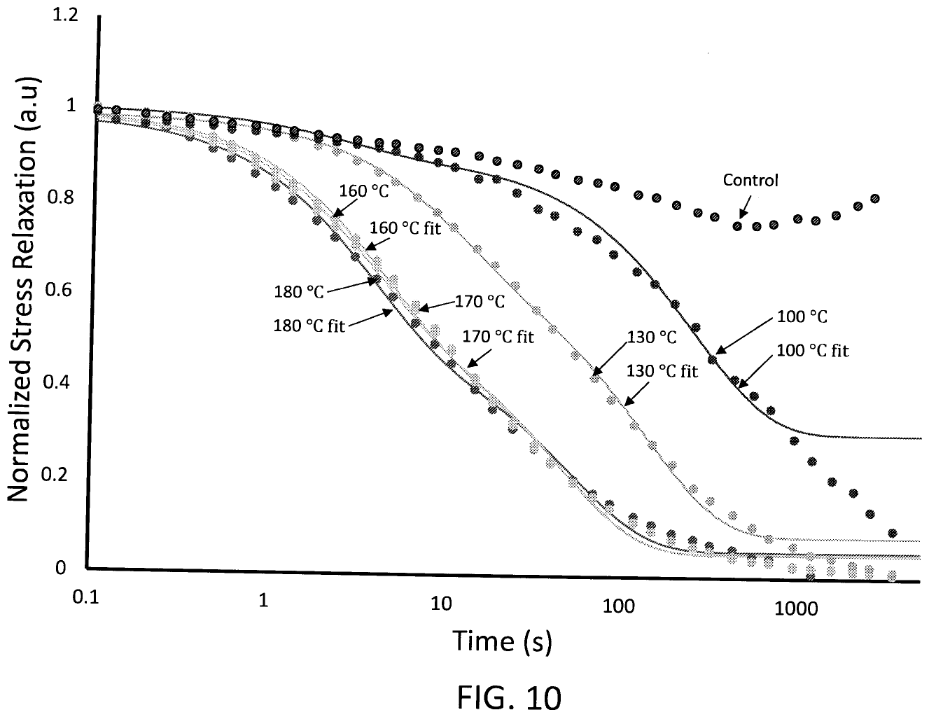

FIG. 9 shows storage modulus measurements on a crosslinked PB-based polymer. The crosslinked polymer network had a storage modulus of ˜3 MPa at room temperature and lacked a clear glass transition temperature. Stress relaxation measurements of the polymer network at different temperatures were obtained (FIG. 10). These measurements showed that the polymer networks completely relax stressed on a times scale of hundreds to thousands of seconds at temperatures between 100-180° C. However, at temperatures above 150° C. the polymer networks started to experience significant amounts of oxidative crosslinking that results in permanent crosslinking of the material and causes the stress relaxation rate to stop increasing with temperature. This crosslinking resulted in stiffer materials and should be avoided by conducting crosslinking and reprocessing at temperatures below that at which oxidative crosslinking becomes significant.

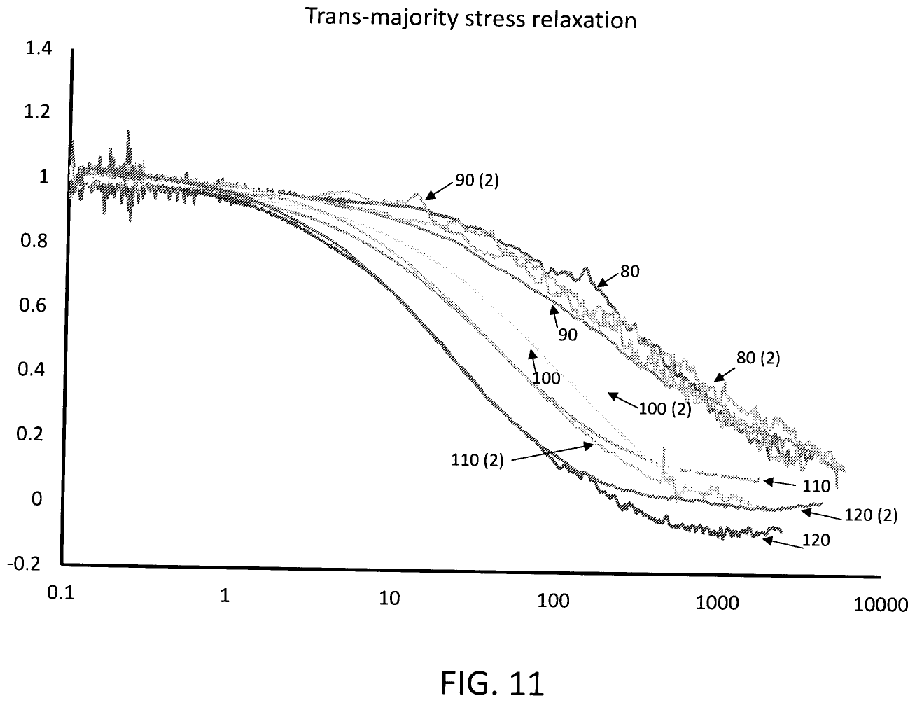

Stress relaxation of the PB-based polymer network was studied at temperatures of 120° C. and below (80° C. to 120° C.) and the results are shown in FIG. 11. Notably, significant amounts of oxidative crosslinking were not observed and the stress relaxation was reproducible.

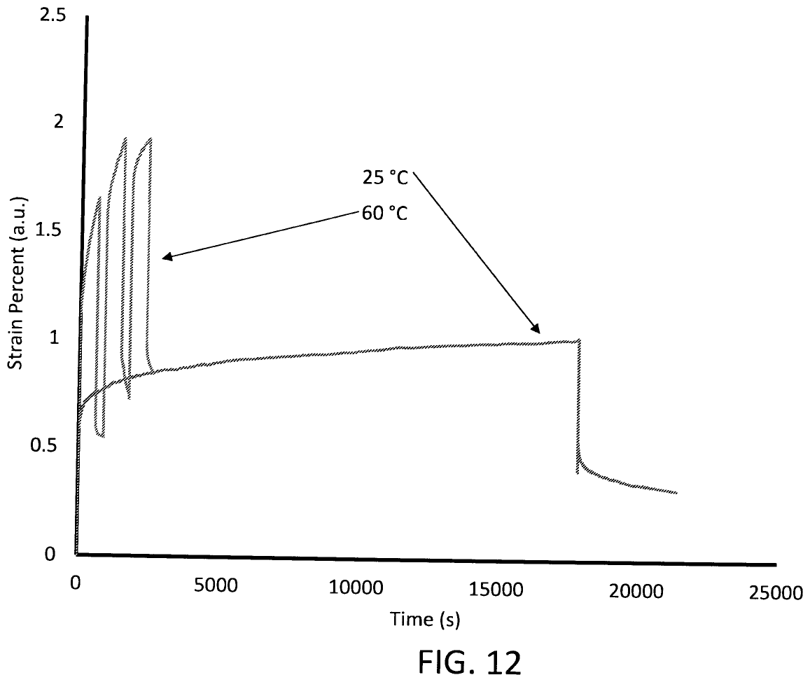

Testing on the extent of material creep for these trans-majority PB-based polymer networks were conducted. At room temperature the materials experienced some amount of permanent deformation over the course of 5 hours (FIG. 12). At 60° C. the rate of deformation was significantly faster, with greater deformation in one 15-minute cycle than in 5 hours at room temperature.

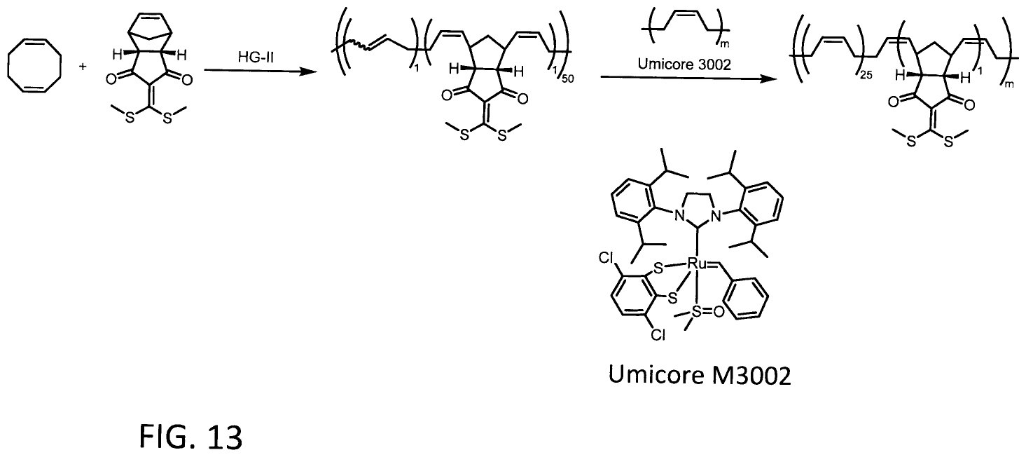

Alternative Olefin Metastasis Catalyst. PB polymers having inserted ND monomers were also synthesized with the catalyst Umicore M3002. (Hoveyda, A. H. J. Am. Chem. Soc. 2013, 135, 10258-10261) To overcome steric hindrance between the catalyst and the dithioalkylidene synthesis was carried out using a modified reaction procedure, shown in FIG. 13. This procedure involved first making a dithioalkylidene rich polymer using the Hoveyda-Grubbs catalyst II (HG-II) catalyst, which then underwent cross-metathesis with the polybutadiene using the Umicore M3002 catalyst to produce a cis-majority (>95% cis double bonds) modified polymer. The details of the synthesis are described below.

Polymerization of ND Rich copolymer. 2-(bis(methylthio)methylene)-3a,4,7,7a-tetrahydro-1H-4,7-methanoindene-1,3 (2H)-dione (500 mg, 1.75 mmol) and Hoveyda-Grubbs II catalyst (43.9 mg, 70.1 μmol) were added to a 25 mL round bottom flask and the flask was evacuated and filled with nitrogen 3 times. THF (8.77 mL) was then added to the flask and the mixture was stirred while the cyclooctadiene (379 mg, 3.51 mmol) was weighed. The cyclooctadiene was then quickly added to the flask using a needle through the septa. The mixture was allowed to stir for 5 hours before excess ethyl vinyl ether was added and stirred for an additional 30 minutes. The polymer was then collected by precipitation and centrifugation in acetone. The ratio of ND to COD was then analyzed by 1H NMR.

Insertion of crosslinker into polybutadiene using Umicore M3002. In a nitrogen glove box, 100 mg of polybutadiene (MW 200,000 to 300,000, primarily cis-1,4) was added to a 2 mL-vial with Umicore M3002 (2.00 mg, 2.50 μmol) and ND rich copolymer (33.7 mg, approximately a 1:25 ratio of ND to total polybutadiene units). Dichloromethane (0.33 mL) was added, and the mixture was capped and allowed to stir in the glove box for 26 hours. After 26 hours the vial was removed from the glove box and an excess of ethyl vinyl ether was added and stirred for an additional 30 minutes. The polymer was collected by precipitation and centrifugation in acetone. Crosslinker incorporation was confirmed through 1H NMR and gel permeation chromatography.

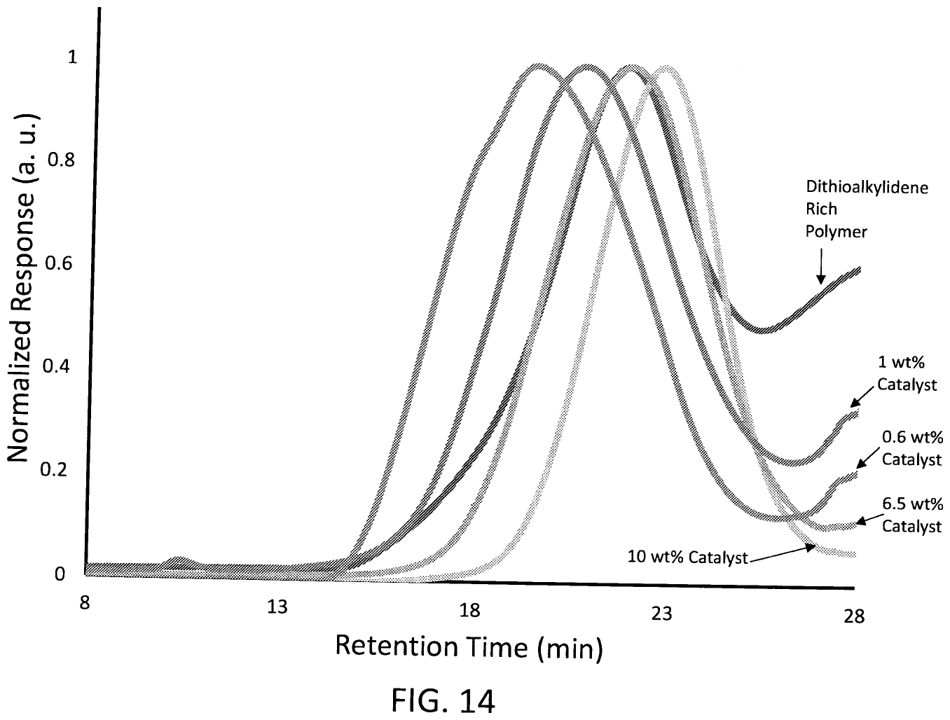

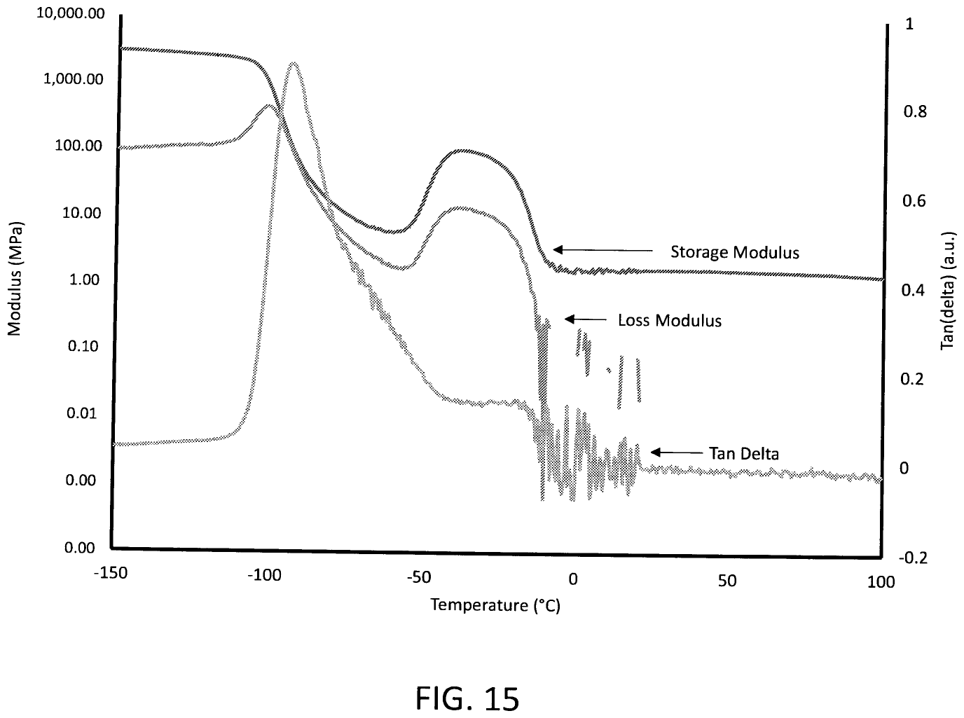

The final MW of the polymers made using the Umicore M3002 was dependent on the amount of catalyst added-ranging from 0.6 to 10 wt. %. As shown in FIG. 14, different concentrations of the catalyst produced very different final MWs. The final polymers were used to form cis-majority polymer networks with different properties compared to the corresponding trans-majority polymer networks. This is illustrated in FIG. 15, which shows the results of a dynamic mechanical thermal analysis of the polymer networks, which had low glass transition temperatures (˜−93° C.), comparable to regular cis-polybutadiene, and a room temperature storage modulus of ˜1.5 MPa.

Primary method of dissolving polymer networks. A polymer film was swelled in a 20 mL vial in dichloromethane. An excess of dithiothreitol was added to the vial along with a drop of triethylamine. The vial was capped and the resulting heterogeneous mixture was shaken by hand until visual inspection showed the complete dissolution of the polymer network.

Secondary method of dissolving polymer networks. A polymer film was added to a 4 mL vial, along with an excess of dodecanethiol. The vial was placed in a small vacuum chamber and subjected to 5 cycles of evacuation and filling with N₂. The vacuum chamber was lowered into an oil bath heated to 120° C. and left overnight. Visual inspection the next morning showed that the polymer network completely dissolved in the excess thiol.

Mechanical recycling of PB-based polymer networks. Mechanical recycling of the PB-based polymer networks was achieved by hot-pressing these materials while heated to temperatures >100° C. Oxidative crosslinking is best avoided by hot-pressing these materials at temperatures between 100-120° C. under nitrogen or vacuum for appropriate lengths of time determined by stress relaxation measurements. Chemical recycling can be achieved by dissolving the material using the procedures described below.

Tertiary method of dissolving polymer networks. A PB-based polymer network was swelled in a 20-mL vial in dichloromethane. An excess of benzyl mercaptan and a drop of triethylamine was added to the vial and the mixture is stirred gently. Visual inspection showed that the entire polymer network dissolved over the course of approximately 3-4 hours.

Recuring dissolved polymer networks for chemical recycling. The dissolved PB-based polymer mixture had the dichloromethane removed in vacuo. The remaining polymer mixture was then added directly back into a Teflon mold and placed in a nitrogen-purged vacuum oven heated to 100° C. and allowed to heat for 1 hour. The mixture was then put under vacuum (<1 torr) and allowed to heat for an additional 2-3 hours until the polymer was no longer tacky to touch.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of forming a crosslinked polymer network having dynamic crosslinks, the method comprising reacting norbornene dithioalkylidene monomers with an organic polymer comprising an unsaturated carbon chain backbone, whereby the norbornene dithioalkylidene monomers are incorporated into the carbon chain backbone via ring-opening and cross-metathesis to form an organic polymer comprising thioether-functionalized polymer backbone chains; and
reacting thioether groups of the thioether-functionalized polymer backbone chains with an organic crosslinker comprising multiple thiol groups to from a crosslinked polymer network.

2. The method of claim 1, wherein the organic polymer comprising the unsaturated carbon chain backbone is a diene elastomer.

3. The method of claim 2, wherein the diene elastomer comprises polybutadiene or polyisoprene.

4. The method of claim 1, wherein the norbornene dithioalkylidene monomers are reacted with the organic polymer comprising the unsaturated carbon chain backbone in the presence of cyclic olefin monomers, wherein the cyclic olefin monomers are incorporated into the carbon chain backbone via ring-opening and cross-metathesis.

5. The method of claim 4, wherein the organic polymer comprising the unsaturated carbon chain backbone is polyisoprene and the cyclic olefin monomers are cyclooctene monomers.

6. The method of claim 4, wherein the norbornene dithioalkylidene monomers are reacted with the organic polymer comprising the unsaturated carbon chain backbone in the presence of an olefin metathesis catalyst.

7. The method of claim 1, wherein the norbornene dithioalkylidene monomers are reacted with the organic polymer comprising the unsaturated carbon chain backbone in the presence of an olefin metathesis catalyst.

8. A crosslinked polymer network comprising a reaction product of:
a linear polymer that is the product of a ring-opening and cross-metathesis reaction between norbornene dithioalkylidene monomers and an organic polymer comprising an unsaturated carbon chain backbone; and
an organic crosslinker comprising multiple thiol groups.

9. The crosslinked polymer network of claim 8, wherein the organic polymer comprising the unsaturated carbon chain backbone is a diene elastomer.

10. The crosslinked polymer network of claim 8, wherein the diene elastomer comprises polybutadiene or polyisoprene.

11. The crosslinked polymer network of claim 8, wherein the product of the ring-opening and cross-metathesis reaction of norbornene dithioalkylidene monomers with an organic polymer comprising the unsaturated carbon chain backbone is a product of ring-opening and cross-metathesis reactions of the norbornene dithioalkylidene monomers and cyclic olefin monomers with the organic polymer comprising the unsaturated carbon chain backbone.

12. The crosslinked polymer network of claim 11, wherein the organic polymer comprising the unsaturated carbon chain backbone is polyisoprene and the cyclic olefin monomers are cyclooctene monomers.

13. A method of reprocessing a crosslinked polymer network comprising a reaction product of: a linear polymer that is the product of a ring-opening and cross-metathesis reaction between norbornene dithioalkylidene monomers and an organic polymer comprising an unsaturated carbon chain backbone; and an organic crosslinker comprising multiple thiol groups, the method comprising dissolving the crosslinked polymer network in a solvent comprising an excess of thiol molecules that undergo thiol exchange with crosslinks in the crosslinked polymer network to sever the crosslinks.

14. The method of claim 13, wherein the thiol molecules comprise one or more thiol groups attached to a linear or branched C₂ to C₁₂ carbon chain.

15. The method of claim 13, wherein thiol molecules comprise dithiothreitol molecules.

16. The method of claim 13, wherein the thiol molecules comprise alkyl thiol molecules.
